(19) United States
(12) Patent Application Publication
(10) Pub. No.: US 2009/0084021 A1
(43) Pub. Date: Apr. 2, 2009

(54) FISHING LURE WITH A RATTLE

(76) Inventors: Marilyn Bialobrzeski, Mesa, AZ (US); Jason Bialobrzeski, Williams, AZ (US); Kenneth Bialobrzeski, Charlotte, NC (US)

Correspondence Address: SCHMEISER OLSEN & WATTS, 18 E UNIVERSITY DRIVE, SUITE # 101, MESA, AZ, 85201, US

(21) Appl. No.: 11/863,083

(22) Filed: Sep. 27, 2007

(51) Int. Cl. A01K 85/01

(52) U.S. Cl. 43/42.31

(57) ABSTRACT

A fishing lure includes a rattle and a foam sleeve. The foam sleeve is carried by the rattle and amplifies an audio signal provided by the rattle. The rattle has a tube with a channel extending through it. The foam sleeve includes closed cell foam with one or more open cells facing the tube. The audio signal flows through the open cell(s).

### BACKGROUND OF THE INVENTION

1. Field of the Invention

This invention relates to fishing with artificial bait.

2. Description of the Related Art

Fishing is a recreational activity enjoyed by many people and often involves using a rod and reel with a lure attached to the end of fishing line. The lure can be live or artificial bait. The artificial bait is often sized so it can be caught by a fish and shaped so that the fish find it attractive. Some artificial bait lures are made to be attractive by appealing to the fish's senses. For example, some artificial bait lures are coated with a material to provide them with an attractive smell. Other artificial bait lures include a shiny metal spoon or a light which the fish can see. In this way, the artificial bait lure is more attractive so a fish is more likely to catch it.

Some artificial lures include rattles which make noise that the fish can hear. For example, U.S. Pat. No. 7,146,764 discloses a rattle cage fishing lure having beads which generate sound when they contact each other and the rattle cage. U.S. Pat. No. 5,499,471 discloses a rattle for attachment to a fishing lure.

### BRIEF SUMMARY OF THE INVENTION

The present invention employs a foam sleeve carried by a rattle, wherein the foam sleeve and rattle are included in a fishing lure. The foam sleeve amplifies an audio signal provided by the rattle. In one embodiment, the rattle has a tube with a channel extending through it and the foam sleeve includes closed cell foam with one or more open cells facing the tube. The audio signal is amplified when it flows through the open cell(s).

These and other features, aspects, and advantages of the present invention will become better understood with reference to the following drawings and description.

### BRIEF DESCRIPTION OF THE DRAWINGS

FIG. 1 is a perspective view of a fishing lure having a rattle and a foam sleeve, in accordance with the invention.

FIG. 2 is a cut-away side view of the fishing lure of FIG. 1, in accordance with the invention.

FIGS. 3 and 4 are perspective and end views, respectively, of the foam sleeve of FIG. 1.

FIG. 5 is a cut-away side view of another embodiment of a fishing lure, in accordance with the invention, having a rattle and foam sleeve, wherein the foam sleeve includes foam with open and closed cells.

FIG. 6 is a block diagram of a method of manufacturing a fishing lure, in accordance with the invention.

### DETAILED DESCRIPTION OF THE INVENTION

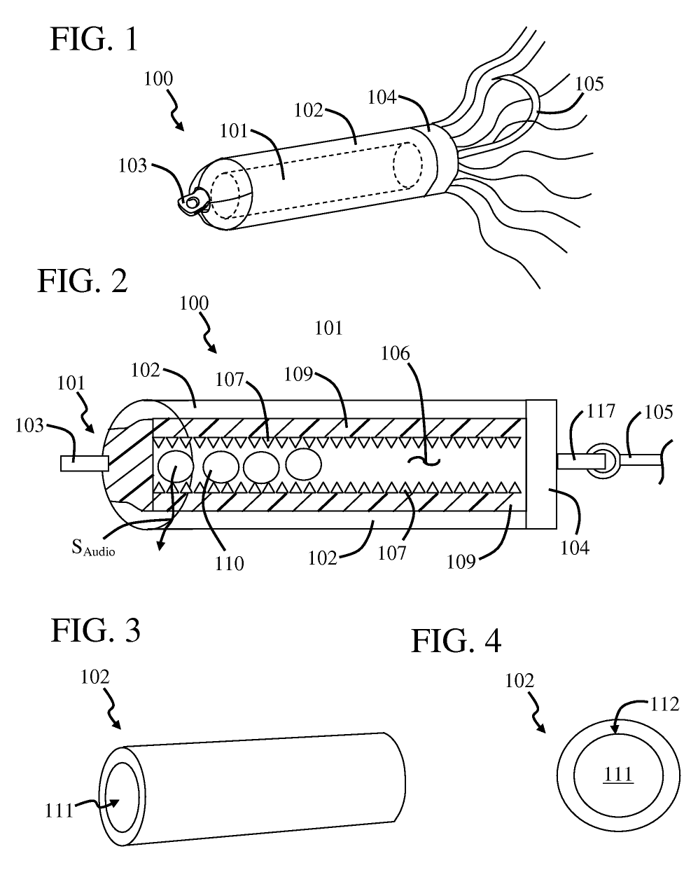

FIG. 1 is a perspective view of a fishing lure 100, in accordance with the invention. In this embodiment, fishing lure 100 includes a rattle 101 and a foam sleeve 102, wherein foam sleeve 102 is carried by rattle 101. Rattle 101 includes an eyelet 103, wherein eyelet 103 is used to attach rattle 101 to a fishing line (not shown). Rattle 101 includes a cap 104, wherein cap 104 is used to attach rattle 101 to a fishing hook 105. Rattle 101 can be of many different types, one of which will be discussed in more detail presently.

FIG. 2 is a cut-away side view of fishing lure 100, in accordance with the invention. In this embodiment, rattle 101 includes a tube 109 extending through foam sleeve 102. Foam sleeve 102 can have many different shapes. However, in this embodiment, foam sleeve 102 has a shape that matches that of tube 109. Here, tube 109 is elongated so that foam sleeve 102 is also elongated, as shown in perspective and end views of foam sleeve 102 in FIGS. 3 and 4, respectively. In this embodiment, foam sleeve 102 includes an opening 111 extending therethrough. Opening 111 is sized and shaped to receive tube 109, wherein tube 109 is frictionally engaged with an inner surface 112 of foam sleeve 102 (FIG. 4). Opening 111 can be formed in many different ways. In this embodiment, opening 111 is formed by cutting through a cylindrical piece of foam to make foam sleeve 102. However, in other embodiments, opening 111 can be formed during the manufacture of foam sleeve 102 by using a mold.

In this embodiment, tube 109 includes a channel 106 extending therethrough, and teeth 107 positioned so they extend through channel 106. Tube 109 can include many different materials, but it includes plastic in this embodiment. Teeth 107 are positioned so they extend from an inner surface of tube 109 and face channel 106. Teeth 107 can be of many different types, such as threads which extend annularly around inner surface 108. Teeth 107 can include many different materials, but here teeth 107 are formed integrally with tube 109 so they include the same material. As discussed above, tube 109 includes plastic so that teeth 107 also include plastic.

In this embodiment, rattle 101 includes beads 110 positioned in channel 106, wherein four beads are shown here for illustrative purposes. Beads 110 can include many different materials, but here they include metal. Beads 110 can have many different shapes, but they are spherical in this embodiment.

Channel 106 can be hermetically sealed by cap 104 so that liquid is restricted from flowing therein. In this way, beads 110 are hermetically sealed in channel 106. However, in other embodiments, channel 106 is not hermetically sealed so that liquid can flow through channel 106. In this embodiment, cap 104 is threadingly engaged with tube 109. In this way, fishing hook 105 is threadingly engaged with rattle 101 because it is carried by cap 104, as discussed above. Fishing hook 105 can be carried by cap 104 in many different ways. In this embodiment, cap 104 includes an eyelet 117 attached to fishing hook 105. In this way, rattle 101 includes one or more eyelets.

In operation, beads 110 move through channel 106 in response to movement of lure 100. In accordance with the invention, an audio signal S_{Audio} flows from rattle 101 in response to the movement of beads 110. Beads 110 engage each other, as well as teeth 107, in response to their movement through channel 106. Hence, audio signal S_{Audio} flows from rattle 101 in response to beads 110 engaging each other and teeth 107. Audio signal S_{Audio} can flow from rattle 101 in many different ways. In this embodiment, audio signal S_{Audio} flows from tube 109 and through foam sleeve 102, where it is amplified as will be discussed in more detail presently.

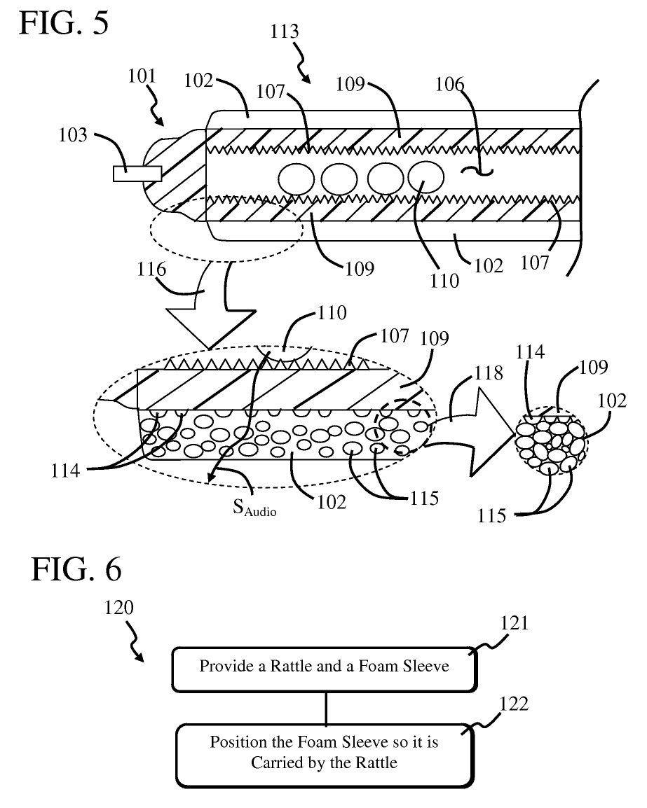

FIG. 5 is a cut-away side view of a fishing lure 113, in accordance with the invention. In this embodiment, fishing lure 113 includes tube 109 with eyelet 103 positioned at one end, wherein tube 109 is frictionally received with foam sleeve 102 as discussed above. However, in this embodiment, tube 101 extends forward of foam sleeve 102. Fishing lure 113 also includes channel 106 extending through tube 109 and beads 110 positioned therein. Further, rattle 101 includes teeth 107 positioned so they extend through channel 106.

In this embodiment, foam sleeve 102 includes foam having open cells 114 and closed cells 115, as indicated by an indication arrow 116. In accordance with the invention, open cells 114 are formed when forming opening 111 through foam sleeve 102, as shown in FIG. 3. For example, open cells 114 can be formed when cutting through a cylindrical piece of foam to form opening 111 and foam sleeve 102. Foam sleeve 102 can include many different types of foam materials, such as polystyrene and polyurethane, among others. More information regarding foam which can be included in foam sleeve 102 is provided in U.S. Pat. No. 6,720,362.

It should be noted that the foam included in foam sleeve 102 can include many different densities of open cells 114 and closed cells 115. For example, the foam included in foam sleeve 102 as indicated by indication arrow 116 includes a smaller density of cells 114 and 115 than the foam included in foam sleeve 102, as indicated by an indication arrow 118. The foam included in foam sleeve 102 as indicated by indication arrow 118 includes a number of cells 114 and 115 so that cells 114 and 115 engage each other.

In accordance with the invention, open cells 114 are formed proximate to and face inner surface 112 of foam sleeve 102 (FIG. 4). In this way, open cells 114 face rattle 101. In particular, open cells 114 face tube 109 when tube 109 is received by opening 111. In operation, audio signal S_{Audio} flows through open cells 114 and so it is amplified. In this way, foam sleeve 102 amplifies audio signal S_{Audio} provided by rattle 101. Further, the frequency of audio signal S_{Audio} is changed in response to it flowing through foam sleeve 102.

FIG. 6 is a block diagram of a method 120 of manufacturing a fishing lure, in accordance with the invention. In this embodiment, method 120 includes a step 121 of providing a rattle and a foam sleeve, and a step 122 of positioning the foam sleeve so it is carried by the rattle. In some embodiments, step 121 includes providing a tube with a channel extending therethrough. In accordance with the invention, the foam sleeve is positioned so it amplifies audio signal S_{Audio} provided by the rattle. The foam sleeve can also change the frequency of audio signal S_{Audio} as it flows through it.

In this embodiment, the foam sleeve includes foam having closed cells and open cells, wherein one or more of the open cells face the rattle. Audio signal S_{Audio} is amplified as it flows through the open cells. The open cells can be formed in many different ways, such as by forming an opening through the foam sleeve, wherein the opening is sized and shaped to receive the rattle. In one particular embodiment, the opening is formed by cutting through a piece of foam to form the foam sleeve, so that the open cells are formed by cutting. It should be noted that the piece of foam is generally cylindrical or it has a shape that matches that of the rattle. Hence, the step of forming the opening includes forming one or more open cells in the foam sleeve.

It should also be noted that method 120 can include many other steps. For example, in some embodiments, method 120 includes a step of providing teeth which extend into the channel of the tube. Method 120 can also include a step of positioning one or more beads in the channel and a step of hermetically sealing the bead(s) in the channel with a cap.

The embodiments of the invention described herein are exemplary and numerous modifications, variations and rearrangements can be readily envisioned to achieve substantially equivalent results, all of which are intended to be embraced within the spirit and scope of the invention.

1. A fishing lure, comprising:
a rattle; and
a foam sleeve carried by the rattle, wherein the foam sleeve amplifies an audio signal provided by the rattle.

2. The lure of claim 1, wherein the foam sleeve includes closed cell foam with one or more open cells facing the rattle.

3. The lure of claim 1, wherein the rattle includes one or more eyelets.

4. The lure of claim 1, wherein the rattle includes a tube with a channel extending therethrough.

5. The lure of claim 4, wherein the rattle includes one or more beads positioned in the channel.

6. The lure of claim 4, wherein a surface of the tube facing the channel includes teeth.

7. The lure of claim 4, wherein the channel is hermetically sealed.

8. A fishing lure, comprising:
a rattle having a tube; and
a foam sleeve carried by the rattle, the foam sleeve including closed cell foam with one or more open cells facing the tube;
wherein the foam sleeve amplifies an audio signal provided by the rattle.

9. The lure of claim 8, wherein the audio signal flows through the open cell(s).

10. The lure of claim 8, wherein the tube includes a channel with teeth extending therethrough.

11. The lure of claim 10, wherein the rattle includes one or more beads positioned in the channel.

12. The lure of claim 11, wherein the audio signal is provided in response to the bead(s) engaging the teeth.

13. The lure of claim 10, further including a cap with hermetically seals the bead(s) in the channel.

14. The lure of claim 13, further including a fishing hook carried by the rattle.

15. A method of manufacturing a fishing lure, comprising:
providing a rattle and a foam sleeve, wherein the rattle includes one or more eyelets; and
positioning the foam sleeve so it is carried by the rattle, wherein the foam sleeve is positioned so it amplifies an audio signal provided by the rattle.

16. The method of claim 15, further including forming an opening which extends through the foam sleeve.

17. The method of claim 15, further including forming one or more open cells in the foam sleeve by cutting through it.

18. The method of claim 15, further including attaching a fishing hook to one of the eyelets.

19. The method of claim 15, further including attaching a fishing line to one of the eyelets.

20. The method of claim 15, wherein the step of providing the rattle includes providing a tube with a channel extending therethrough.
